(19) United States
(12) Patent Application Publication
(10) Pub. No.: US 2021/0061504 A1
(43) Pub. Date: Mar. 4, 2021

(54) Packaging Apparatus and Methods of Using Same

(71) Applicant: Sorinex Exercise Equipment, Inc., Lexington, SC (US)

(72) Inventor: Kyle Evin Simpson, Columbia, SC (US)

(73) Assignee: Sorinex Exercise Equipment, Inc., Lexington, SC (US)

(21) Appl. No.: 17/012,799

(22) Filed: Sep. 4, 2020

Related U.S. Application Data
(60) Provisional application No. 62/895,577, filed on Sep. 4, 2019.

(51) Int. Cl. B65B 31/02; B65D 21/02; B29C 45/16

(52) U.S. Cl. CPC B65B 31/028; B29L 2031/26; B29C 45/1676; B65D 21/0233

(57) ABSTRACT

A packaging apparatus, comprising: a top configured for receipt of a payload therein and including a lip around a perimeter of top; and, a bottom configured for receipt of the payload therein and formed as a counterpart to the top, wherein the top and bottom are formed from the same mould and are identical but for the lip which is not included in the bottom.

### RELATED APPLICATION

This application claims the benefit of priority under 35 USC § 119(e) of U.S. Provisional Patent Application No. 62/895,577 filed Sep. 4, 2019, the contents of which are incorporated herein by reference in their entirety.

### FIELD AND BACKGROUND OF THE INVENTION

The present invention, in some embodiments thereof, relates to packaging and, more particularly, but not exclusively, to a packaging solution for exercise equipment.

### SUMMARY OF THE INVENTION

According to an aspect of some embodiments of the present invention there is provided a formed packaging apparatus for organizing and/or shipping and/or storing exercise equipment.

According to a further aspect of some embodiments of the present invention there is provided a method of using a plurality of formed packaging apparatuses for efficient space utilization.

According to a further aspect of some embodiments of the invention, there is provided a packaging apparatus, comprising: a top configured for receipt of a payload therein and including a lip around a perimeter of top; and, a bottom configured for receipt of the payload therein and formed as a counterpart to the top, wherein the top and bottom are formed from the same mould and are identical but for the lip which is not included in the bottom.

In an embodiment of the invention, the bottom is nestable within the top.

In an embodiment of the invention, the lip is disposed around the perimeter of a lower edge of the top, facing the bottom when the packaging apparatus is fully assembled.

In an embodiment of the invention, the lip covers a junction between the top and the bottom.

In an embodiment of the invention, the lip is provided with sealing material, rendering the packaging apparatus water-proof and/or air tight by sealing the junction between the top and the bottom.

In an embodiment of the invention, sealing material is provided at the junction, rendering the packaging apparatus water-proof and/or air tight by sealing the junction between the top and the bottom.

In an embodiment of the invention, the payload is a kit of exercise equipment.

In an embodiment of the invention, the kit includes at least one weight, weight bar, bell, or other weightlifting accessory.

In an embodiment of the invention, the apparatus further comprises a locking mechanism to lock the top to the bottom.

In an embodiment of the invention, the locking mechanism comprises at least one of a clasp, buckle, latch, screw, or snap.

In an embodiment of the invention, the top and the bottom are provided with protrusions which externally function as legs for the packaging apparatus, but which internally create a void for storage of exercise equipment or accessories therein.

In an embodiment of the invention, the bottom is provided with a ledge disposed on an upper edge of the bottom which contacts the top at a junction between the top and the bottom.

In an embodiment of the invention, the top and bottom are formed with at least one compartment, slot, site, or void for placement of at least a part of the payload therein.

In an embodiment of the invention, the apparatus further comprises at least one closable compartment, strap, band clasps, loop or hook to secure the payload within the packaging apparatus.

In an embodiment of the invention, the a plurality of bottoms are nestable within a plurality of tops in alternating fashion.

According to a further aspect of some embodiments of the invention, there is provided a method of using a packaging apparatus, comprising: at least partially loading a bottom of a packaging apparatus with a payload; placing a top of the packaging apparatus, formed identically to the bottom with the addition of a lip on a lower edge of the top when the packaging apparatus is fully assembled, on the bottom of the packaging apparatus wherein the lip covers a junction between the top and the bottom; removing the top from the bottom to access the payload; performing at least one of unloading the payload and stacking the bottom on the top so that the bottom is nested within the top.

In an embodiment of the invention, the method further comprises reversibly locking the top to the bottom using a locking mechanism.

In an embodiment of the invention, the method further comprises transporting the packaging apparatus with the top on the bottom and the payload inside.

According to a further aspect of some embodiments of the invention, there is provided a method of manufacturing a packaging apparatus, comprising: moulding a top and a bottom identical to the top using the same mould; and, cutting a lip off an upper edge of the bottom, wherein the lip of the top covers a junction where the top and the bottom meet when the packaging apparatus is fully assembled.

In an embodiment of the invention, the method further comprises adding a sealant to at least one of the top, bottom or lip to render the packaging apparatus water-proof and/or air tight when fully assembled.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings and images. With specific reference now to the drawings in detail, it is stressed that the particulars shown are by way of example, are not necessarily to scale, and are for purposes of illustrative discussion of embodiments of the invention. In this regard, the description taken with the drawings makes apparent to those skilled in the art how embodiments of the invention may be practiced.

In the drawings:

FIG. 1 is an isometric view of a closed, packaging apparatus, including the top and bottom;

FIG. 2 is an isometric side front of a closed, packaging apparatus, including the top and bottom;

FIG. 3 is an isometric view of a top of a packaging apparatus;

FIG. 4 is a reverse isometric view of the top of a packaging apparatus (viewing the bottom of the top of the packaging apparatus);

FIG. 5 is a top view of the top of a packaging apparatus;

FIG. 6 is a bottom view of the top of a packaging apparatus;

FIG. 7 is a front view of the top of a packaging apparatus;

FIG. 8 is a back view of the top of a packaging apparatus;

FIG. 9 is a left view of the top of a packaging apparatus;

FIG. 10 is a right view of the top of a packaging apparatus;

FIG. 11 is an isometric view of a bottom of a packaging apparatus;

FIG. 12 is a reverse isometric view of the bottom of a packaging apparatus;

FIG. 13 is an isometric view of a partially loaded packaging apparatus;

FIG. 14 is an isometric view of a stacked and loaded packaging apparatus; and,

FIG. 15 is a flowchart of a method of using a packaging apparatus.

### DESCRIPTION OF SPECIFIC EMBODIMENTS OF THE INVENTION

The present invention, in some embodiments thereof, relates to packaging and, more particularly, but not exclusively, to a packaging solution for exercise equipment.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

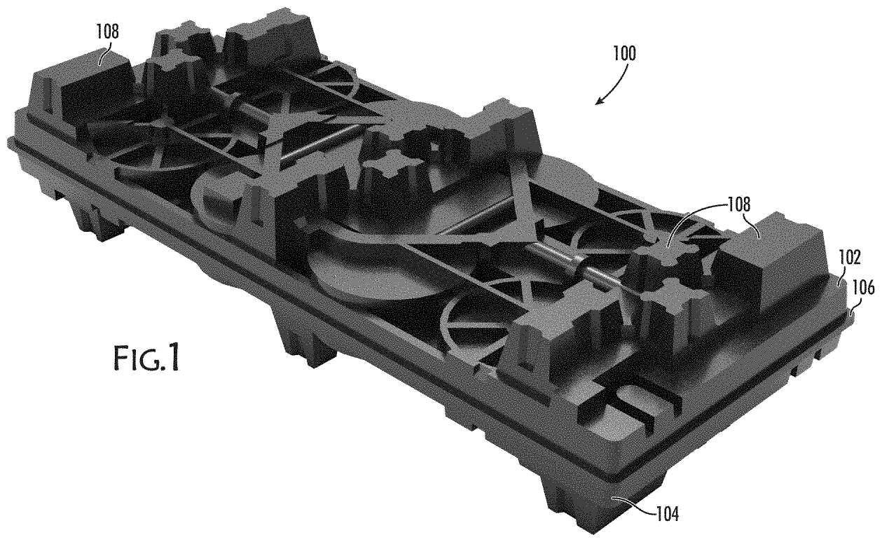

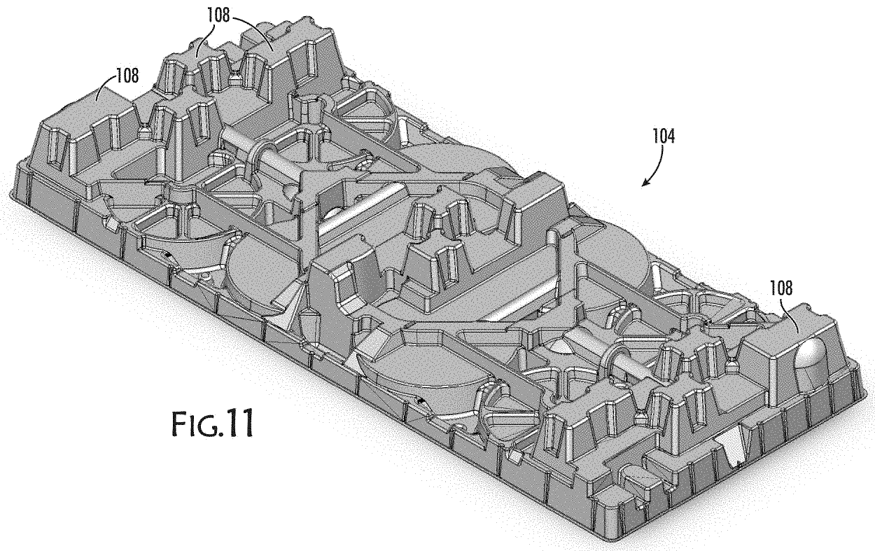

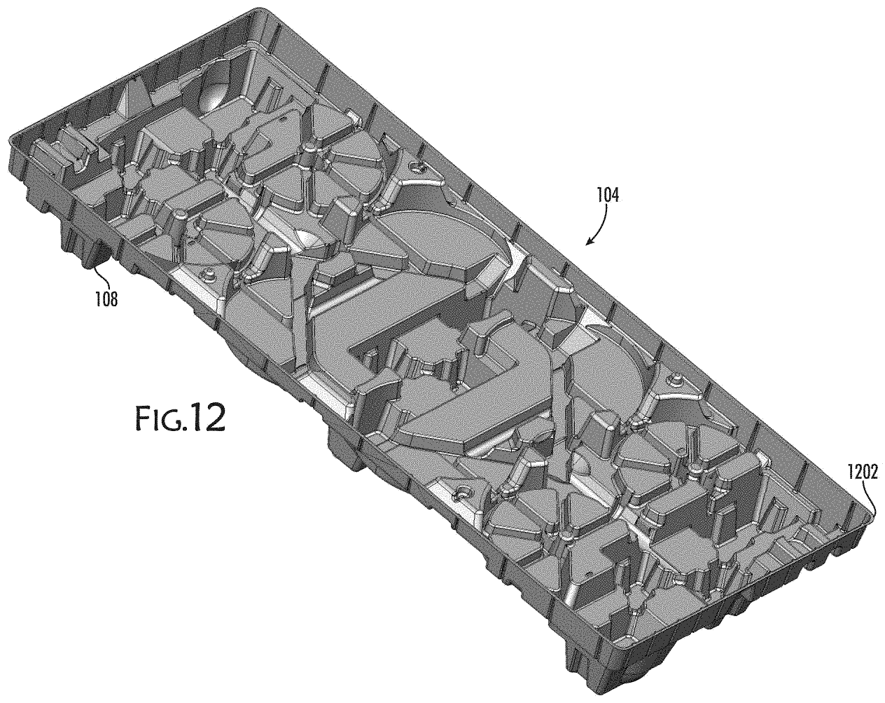

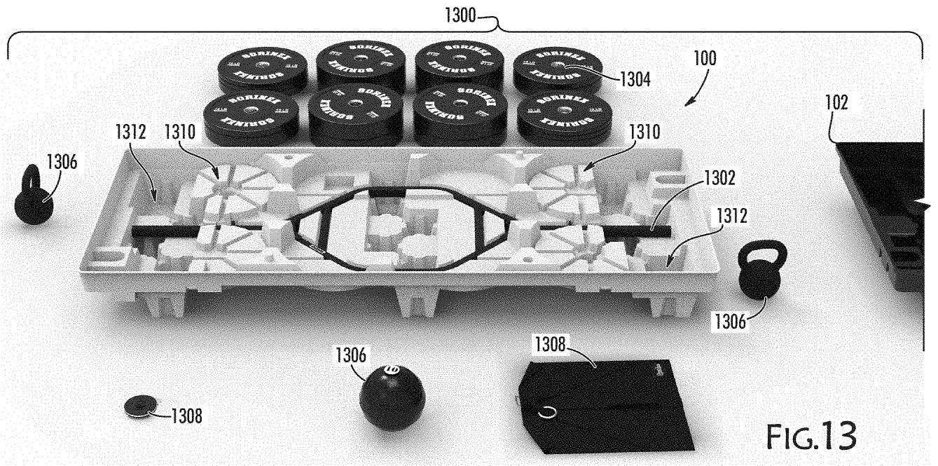

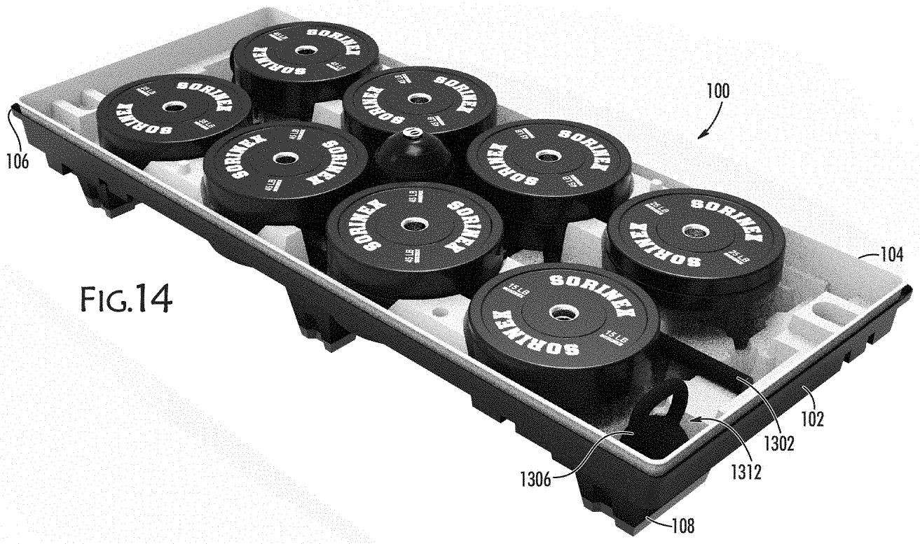

Referring now to the drawings, FIG. 1 is an isometric view of a closed, packaging apparatus 100, including the top 102 and bottom 104. In some embodiments of the invention, the packaging apparatus 100 is custom formed for receipt and storage therein of an intended payload of exercise equipment 1300 (shown in FIGS. 13 and 14), for example weights, weight bars, bells, and other weightlifting accessories, such as shown in more detail in FIGS. 11 and 12. In some embodiments of the invention, the packaging apparatus 100 is used for securely shipping the exercise equipment stored therein.

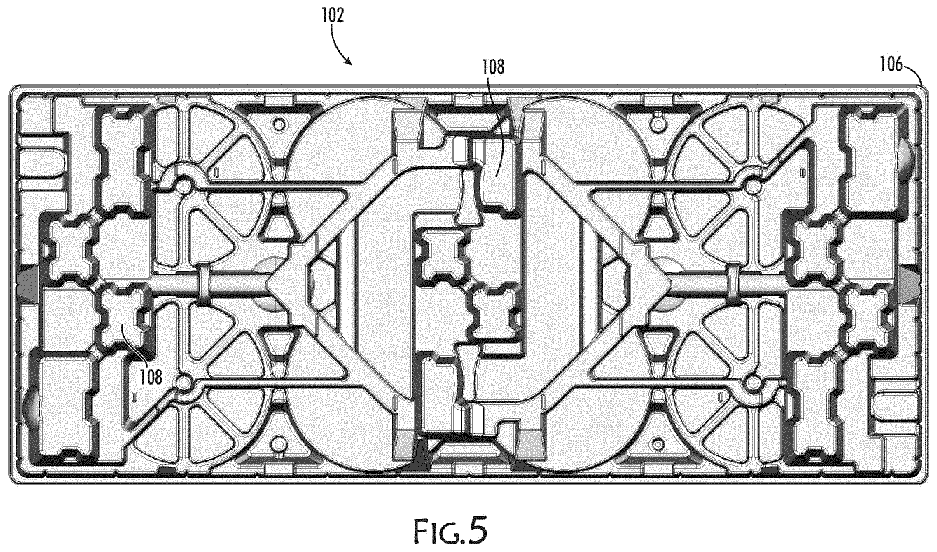

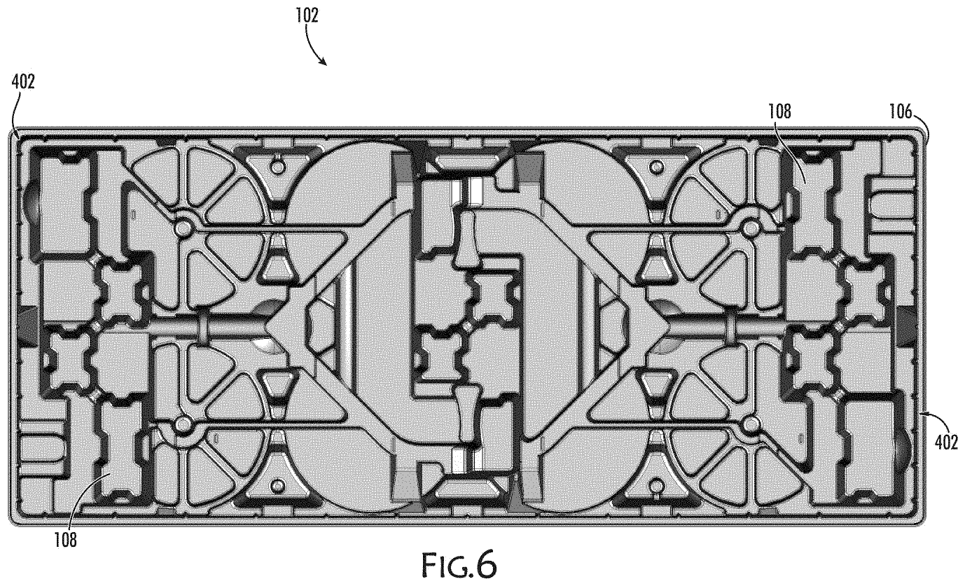

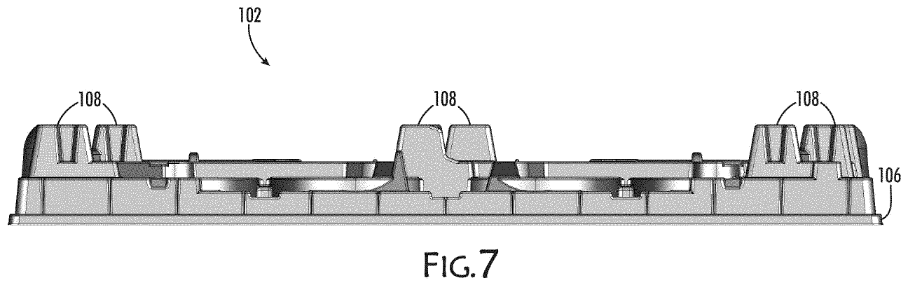

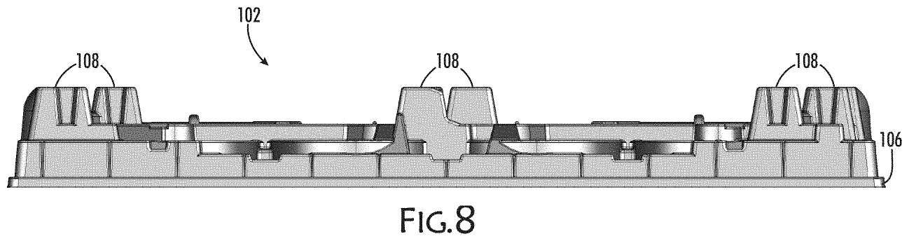

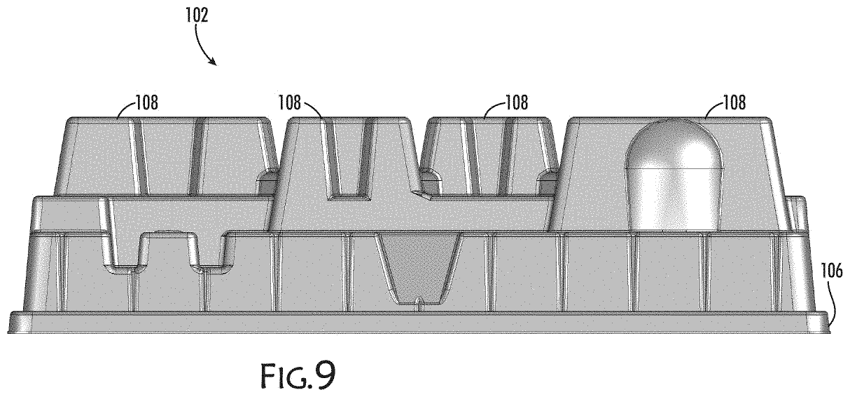

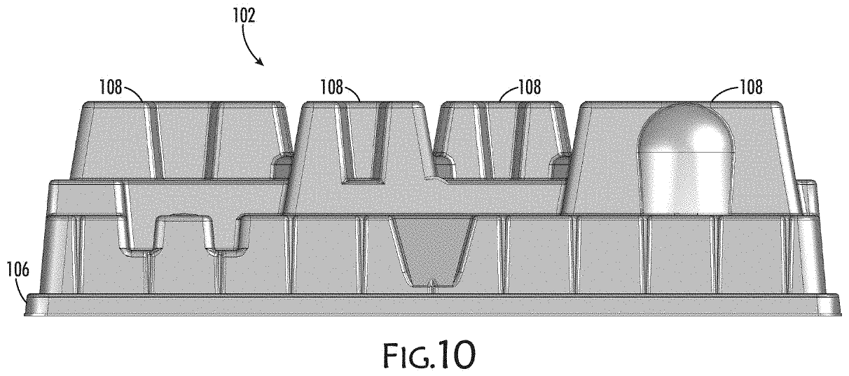

It should be understood that in some embodiments of the invention, the top 102 and/or bottom 104 are formed according to what will be stored within the packaging apparatus 100 and could be customized (even including movable and/or modular blocks, walls and/or parts within the inside of the packaging apparatus 100) for an intended cargo. For example, the top 102 and bottom 104 shown in FIGS. 1-14 are customized to fit a kit of exercise equipment, where the kit is designed to be a self-contained exercise solution. As shown in FIGS. 1-14, and this is by way of example only, the kit includes a weight bar 1302 (e.g. the Sorinex® Diamond Bar™ available at the URL www.sorinex.com/products/diamond-bar) and a plurality of exercise weights (e.g. “bumpers” 1304, plates and/or bells 1306) optionally of differing weight amounts and/or sizes and/or types and/or exercise accessories 1308.

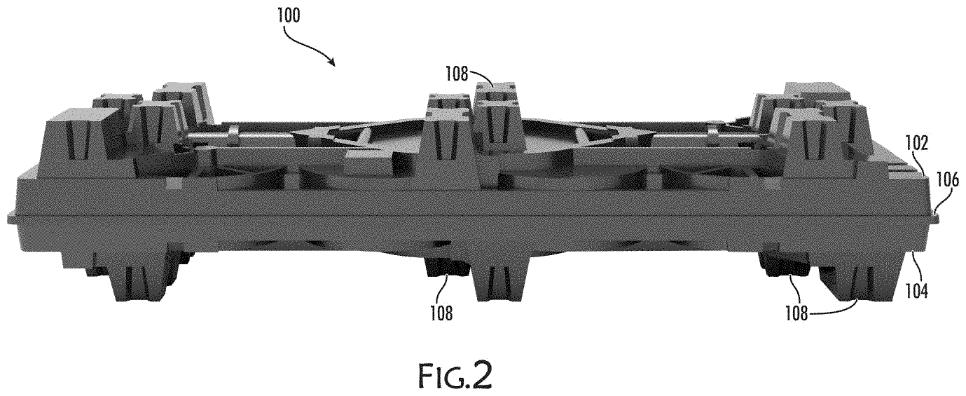

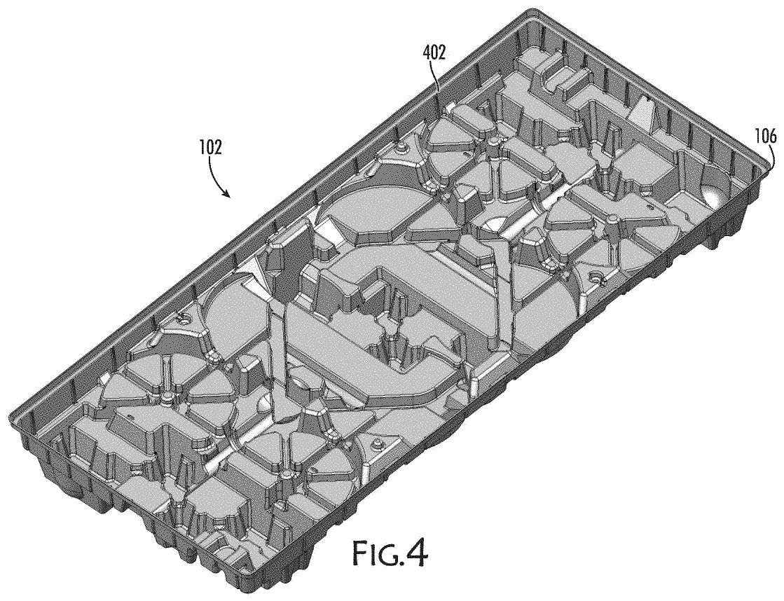

In some embodiments of the invention, the top 102 and bottom 104 are formed from the same mould and are therefore, identical. However, a lip 106 which is formed in both the top 102 and the bottom 104 during moulding is cut off of the bottom 104 during manufacture so that the bottom 104 can nest within the top 102, such as shown in FIGS. 1 and 2. The lip 106, which is thusly disposed at the junction between the top 102 and the bottom 104 provides a covering to the junction and is optionally provided with sealing material so that when the top 102 is placed over the bottom 104, the packaging apparatus 100 is rendered water-proof and/or airtight by the sealing lip 106. Optionally, the seal is not located on the lip, but between the top 102 and the bottom 104 where they adjoin (e.g. at a ledge 402, shown in FIG. 4). Sealing can be achieved using any material which is substantially water and/or air proof, such as rubber and/or artificial equivalents. In some embodiments, a locking mechanism, for example clasps, buckles, latches, screws, snaps, and/or any other device, is used for reversibly locking the top 102 to the bottom 104 in a tight enough relationship prevent the contents of the packaging apparatus 100 from escaping, and in some embodiments, rendering the packaging apparatus 100 waterproof and/or airtight.

In some embodiments of the invention, and shown in more detail with respect to FIG. 2, the top 102 and bottom 104 are formed with protrusions 108 which externally function as legs for the packaging apparatus 100 externally, but which optionally internally create a void for storage of exercise equipment or accessories therein, such as shown in FIG. 14 where a bell 1306 is placed into one of these voids 1312.

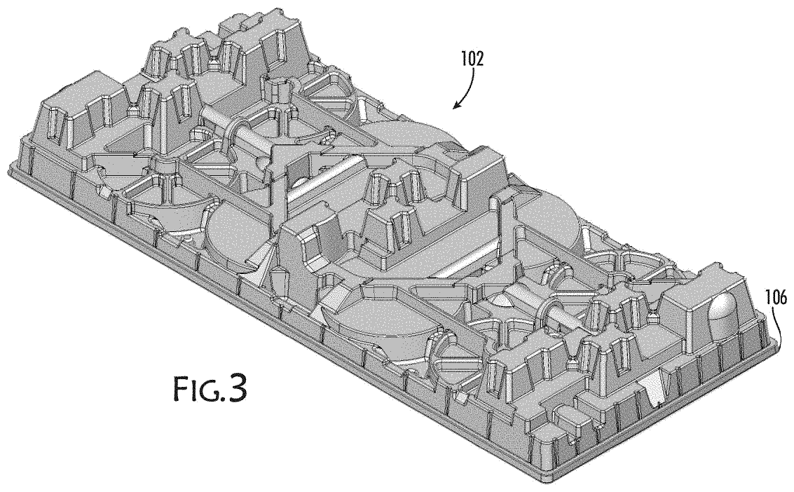

FIGS. 3-10 show different views of the top 102 of the formed packaging apparatus 100 in accordance with an exemplary embodiment of the invention, including FIGS. 3 and 4 which show isometric views of the top 102 from the upper-facing side and the top 102 from the underside (the side facing the contents of the apparatus 100), respectively. FIG. 4 shows more clearly the ledge 402 where an upper edge 1202 of the bottom 104, shown in more detail in FIG. 12, would contact the top 102 when the packaging apparatus 100 is assembled (i.e. the top 102 is placed on the bottom 104).

FIG. 11 is an isometric view of the ground-facing side of the bottom 104 of the formed packaging apparatus 100, in an exemplary embodiment of the invention. FIG. 12 shows the underside of the bottom 104 (the side facing the contents of the packaging apparatus 100).

FIG. 13 is an isometric view of a partially loaded formed packaging apparatus 100 where it is demonstrated that the packaging apparatus 100 is optionally custom-formed for the intended contents, for example, the Sorinex® Diamond Bar™ weight bar 1302 is placed within a preformed slot. It can also be seen that additional sites 1310 are provided for placement of bumpers 1304 and voids 1312 are provided for placement of other equipment, such as bells 1306. It should be understood that while packaging apparatus 100 is shown with the contents being loaded into the bottom 104, in some embodiments of the invention, contents are also loaded and/or are secured to the top 102, for example by using closable compartments, straps, bands, clasps, loops, hooks, and the like.

FIG. 14 is an isometric view of a loaded formed packaging apparatus 100, wherein the bottom 104 is stacked onto an upside-down top 102, and where it can be seen that in order to be space efficient, the top 102 and bottom 104 are stackable, including in combination with a plurality of tops and bottoms of other packaging apparatuses.

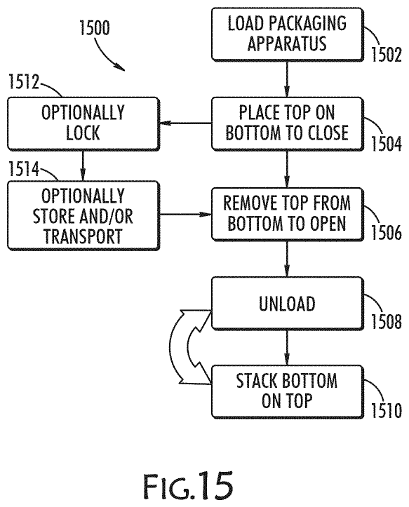

FIG. 15 is a flowchart 1500 of a method of using a formed packaging apparatus 100, in accordance with an exemplary embodiment of the invention. In some embodiments, the packaging apparatus 100 is loaded (1502) with at least some of the intended payload or contents. Optionally, loading (1502) is accomplished according to an pre-planned sequence such that the contents are stacked in an intended order based on the form of the packaging apparatus 100 and/or for space efficiency considerations. The top 102 is placed (1504) on the bottom 104 to close the packaging apparatus 100, optionally to ready the apparatus 100 for reversibly locking (1512) it and/or for storage and/or for transport (1514). When it is desirable to access the contents of the packaging apparatus 100, the top 102 is removed (1506) from the bottom 104, optionally after unlocking them, in an embodiment of the invention. The contents are unloaded (1508) from the packaging apparatus 100 and/or the bottom 104 is stacked (1510) on the top 102 in order to realize space-saving efficiency since the bottom 104 is formed to be nestable within the top 102, when the top 102 is flipped over. It should be understood that unloading (1508) and stacking (1510) can be reversed in the sequence of actions taken in the method.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The term “plurality” means “two or more”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A packaging apparatus, comprising:
a top configured for receipt of a payload therein and including a lip around a perimeter of top; and,
a bottom configured for receipt of the payload therein and formed as a counterpart to the top,
wherein the top and bottom are formed from the same mould and are identical but for the lip which is not included in the bottom.

2. The packaging apparatus according to claim 1, wherein the bottom is nestable within the top.

3. The packaging apparatus according to claim 1, wherein the lip is disposed around the perimeter of a lower edge of the top, facing the bottom when the packaging apparatus is fully assembled.

4. The packaging apparatus according to claim 3, wherein the lip covers a junction between the top and the bottom.

5. The packaging apparatus according to claim 4, wherein the lip is provided with sealing material, rendering the packaging apparatus water-proof and/or air tight by sealing the junction between the top and the bottom.

6. The packaging apparatus according to claim 4, wherein sealing material is provided at the junction, rendering the packaging apparatus water-proof and/or air tight by sealing the junction between the top and the bottom.

7. The packaging apparatus according to claim 1, wherein the payload is a kit of exercise equipment.

8. The packaging apparatus according to claim 7, wherein the kit includes at least one weight, weight bar, bell, or other weightlifting accessory.

9. The packaging apparatus according to claim 1, further comprising a locking mechanism to lock the top to the bottom.

10. The packaging apparatus according to claim 9, wherein the locking mechanism comprises at least one of a clasp, buckle, latch, screw, or snap.

11. The packaging apparatus according to claim 1, wherein the top and the bottom are provided with protrusions which externally function as legs for the packaging apparatus, but which internally create a void for storage of exercise equipment or accessories therein.

12. The packaging apparatus according to claim 1, wherein the bottom is provided with a ledge disposed on an upper edge of the bottom which contacts the top at a junction between the top and the bottom.

13. The packaging apparatus according to claim 1, wherein the top and bottom are formed with at least one compartment, slot, site, or void for placement of at least a part of the payload therein.

14. The packaging apparatus according to claim 1, further comprising at least one closable compartment, strap, band clasps, loop or hook to secure the payload within the packaging apparatus.

15. The packaging apparatus according to claim 2, wherein a plurality of bottoms are nestable within a plurality of tops in alternating fashion.

16. A method of using a packaging apparatus, comprising:
at least partially loading a bottom of a packaging apparatus with a payload;
placing a top of the packaging apparatus, formed identically to the bottom with the addition of a lip on a lower edge of the top when the packaging apparatus is fully assembled, on the bottom of the packaging apparatus wherein the lip covers a junction between the top and the bottom;
removing the top from the bottom to access the payload;
performing at least one of unloading the payload and stacking the bottom on the top so that the bottom is nested within the top.

17. The method according to claim 16, further comprising reversibly locking the top to the bottom using a locking mechanism.

18. The method according to claim 16, further comprising transporting the packaging apparatus with the top on the bottom and the payload inside.

19. A method of manufacturing a packaging apparatus, comprising:
moulding a top and a bottom identical to the top using the same mould; and,
cutting a lip off an upper edge of the bottom,
wherein the lip of the top covers a junction where the top and the bottom meet when the packaging apparatus is fully assembled.

20. The method according to claim 19, further comprising adding a sealant to at least one of the top, bottom or lip to render the packaging apparatus water-proof and/or air tight when fully assembled.
